(19) United States
(12) Patent Application Publication
(10) Pub. No.: US 2011/0115407 A1
(43) Pub. Date: May 19, 2011

(54) SIMPLIFIED CONTROL OF COLOR TEMPERATURE FOR GENERAL PURPOSE LIGHTING

(75) Inventors: Josh Wibben, New Brighton, MN (US); Kurt Kimber, Minneapolis, MN (US); Crispin Metzler, Hastings, MN (US)

(73) Assignee: POLAR SEMICONDUCTOR, INC., Bloomington, MN (US)

(21) Appl. No.: 12/946,421

(22) Filed: Nov. 15, 2010

Related U.S. Application Data
(60) Provisional application No. 61/261,067, filed on Nov. 13, 2009.

(51) Int. Cl. H05B 37/02

(52) U.S. Cl. 315/294

(57) ABSTRACT

A lighting system includes at least first and second light sources providing first and second colors of light. Control circuitry is operatively coupled to the first and second light sources, and is configured to control the first and second light sources relative to one another to provide a color point that is linearly controlled to approximate a non-linear target lighting behavior in the CIE 1931 color space.

### CROSS-REFERENCE TO RELATED APPLICATION(S)

This application claims the benefit of U.S. Provisional Application No. 61/261,067 filed Nov. 13, 2009 for “Simplified Control of Color Temperature for General Purpose Lighting” by J. Wibben, K. Kimber and C. Metzler.

### INCORPORATION BY REFERENCE

U.S. Provisional Application No. 61/261,067 is hereby incorporated by reference in its entirety.

### BACKGROUND

The present invention relates to general purpose lighting, and more specifically to white lighting with a user-controllable adjustable color temperature and/or intensity that is realized with two or more different colored lights.

There are many applications in which lighting having a controllable color temperature and/or intensity is desirable. Systems have been provided in which color temperature is controlled with a variety of light combinations utilizing two or more different colors, controlled by software implemented in a processor, microcontroller or computer, for example. The control of the different light colors to achieve a certain color temperature may involve the use of a lookup table or an algorithm such as the Newton-Raphson method (see, e.g., U.S. Pat. No. 6,379,022). The color temperature curve of a black body radiator on the CIE 1931 Color Space Chromaticity diagram may be approximated using a second order polynomial equation in the control of the different light colors. In any of these situations, the color temperature has been controlled using nonlinear methods and processing equipment and techniques for performing those methods.

The prior techniques for controlling color temperature are relatively complex, making it difficult to provide a low cost solution. The hardware utilized in these systems employs some form of processor that adds to the overall system complexity and cost, particularly when the lighting is realized with a power integrated circuit (IC) system. In addition, the control methods that have previously been employed require complicated software, which necessitates digital hardware having sufficient memory and processing capability to execute this software. This complex digital hardware not only adds cost, but can potentially affect the efficiency of the system.

### SUMMARY

A lighting system according to the present invention includes at least first and second light sources providing first and second colors of light. Control circuitry is operatively coupled to the first and second light sources, and is configured to control the first and second light sources relative to one another to provide a color point that is linearly controlled to approximate a non-linear target lighting behavior in the CIE 1931 color space.

### BRIEF DESCRIPTION OF THE DRAWINGS

FIG. 1 is a diagram depicting a black body radiator locus on the CIE 1931 Color Space Chromaticity diagram, showing the location of a range of color from cool to warm white color temperatures in the color space.

FIG. 2 is a diagram showing the color temperature control that can be achieved by a combination of two originating colors (cool white and yellow).

FIG. 3 is a diagram showing the color temperature control that can be achieved by the combination of cool white and warm white lights.

FIG. 4 is a diagram showing the color temperature control that can be achieved by a combination of three originating colors (red, green and cool white).

FIG. 5 is a diagram of an LED driver circuit in which the current in three LED strings is regulated using three separate switch mode power supplies (SMPS).

FIG. 6 is a diagram of an LED driver circuit which employs a single SMPS, and which is configured to regulate the current in the three LEDs with three linear current sinks.

FIG. 7 is a waveform diagram illustrating the effect of changing the intensity setting input on the reference current and the forward current for all three channels and all three strings of LEDs.

FIG. 8 is a waveform diagram showing a PWM dimming method driving an LED string with a fixed forward current, with the light intensity being controlled by varying the LED on time versus off time (duty cycle) at a fixed frequency.

FIG. 9 is a diagram illustrating a linear fit to the black body radiator locus for color temperature in the CIE 1931 color space.

FIG. 10 is a diagram showing a plot of the individual color intensities of red, green and white for various control levels to provide the color temperature line of FIG. 9.

FIG. 11 is a diagram of the luminous flux achieved for various control levels of red, green and white.

FIG. 12 is a diagram showing the inverted control of the white LED, illustrating that in this configuration the color intensities are linear and all intersect at the same point (zero).

FIG. 13 is a diagram of a circuit for implementing the gain in each channel with a variable resistor divider (a potentiometer) so that the color mix can be easily tuned.

FIG. 14 is a diagram showing the PWM waveforms, the control level signal and the PWM level signal to the PWM input from the resistor divider network of FIG. 13.

FIG. 15 is a diagram illustrating the relationship between luminous flux and control level in a modified system where intensity is correlated with color temperature.

FIG. 16 is a diagram illustrating the color intensity relationship that results from the modified system control shown in FIG. 15.

FIG. 17 is a diagram of the resulting color intensity relationship from the reduction to two LEDs in the red and green strings of the system of FIGS. 15 and 16.

FIG. 18 is a diagram of the luminous flux output for various color temperatures in the reduced LED system of FIG. 17.

### DETAILED DESCRIPTION

The present invention, described below with respect to exemplary embodiments, provides a general purpose white lighting system that offers control of both intensity and color temperature by the user. The embodiments described focus on solutions realized with light emitting diodes (LEDs), but it should be noted that other types of lights may also be used to realize the invention, including but not limited to organic light emitting diodes (OLEDs) or any other type of light with or without a filter, phosphorus, or fluorescent. These lights may all be used in some form with the methods of control described below that provide adjustable color temperature.

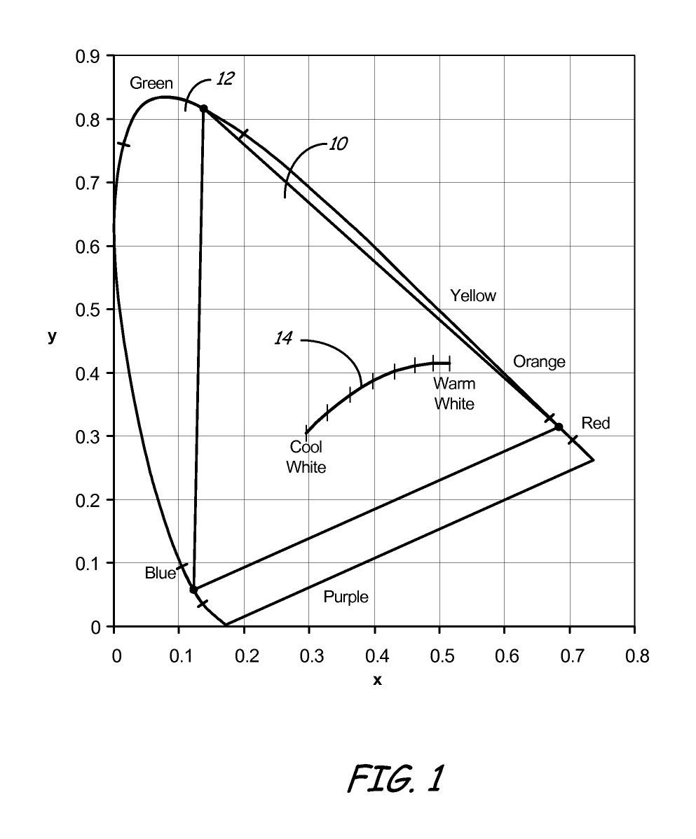

FIG. 1 is a diagram depicting a black body radiator locus 14 on the CIE 1931 Color Space Chromaticity diagram, showing the location of a range of color from cool to warm white color temperatures in the color space. Typically, red, green and blue (RGB) colored LEDs are used to realize adjustable color, and as shown in FIG. 1, the combination of these three colors can generate colors within triangle 10, which covers the majority of the colors that can be perceived by the human eye, shown as parabola 12. The CIE 1931 Color Space Chromaticity diagram is normally shaded with corresponding colors, but for ease of reproduction herein the colors of the diagram are simply depicted by text labels of the appropriate colors.

As shown in FIG. 1, cool white has a color temperature in the area of 5700K and is on the left side of the locus, and warm white has a color temperature in the area of 2700K and is near the right side of the locus. These color temperatures only occupy a small region of the overall color space—as can be seen in FIG. 1, the combination of red, green and blue light provides more flexibility that is required to produce white light with a variable color temperature.

The “efficiency” of a lighting system is measured in terms of efficacy. Efficacy is measured in lumens per watt, and is different than a traditional measure of efficiency because the units in the numerator and the denominator are different. Realizing a warm white color temperature with a combination of high brightness and high efficacy RGB LEDs results in a system efficacy that is much lower than just a white LED with an equivalent color temperature, with present LED technology. Generating a cool white color with RGB LEDs results in a system efficacy that is less than half the efficacy of just a white LED with the equivalent color temperature. Thus, taking into account both complexity and efficacy, the present invention describes light combinations for realizing variable color temperature other than RGB that provide higher efficacy at lower cost.

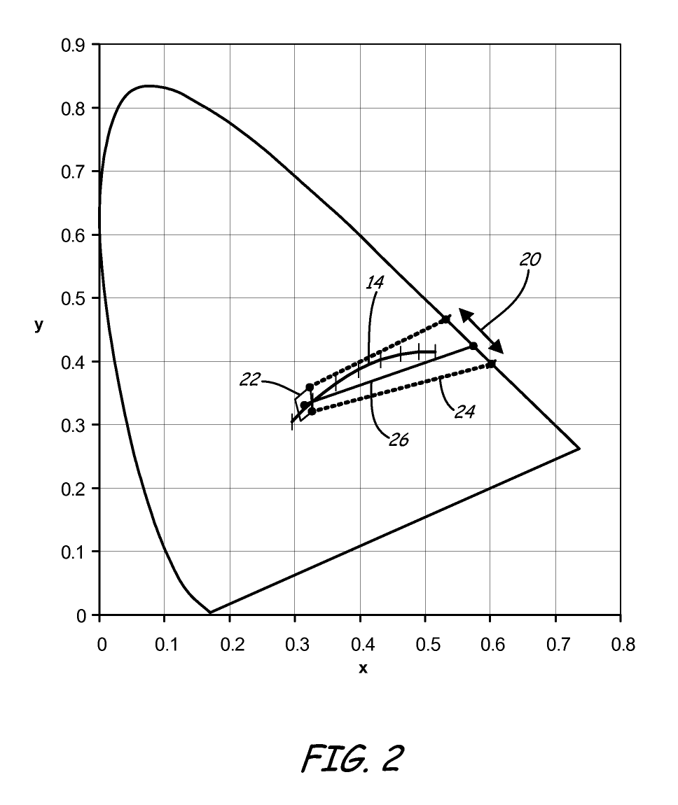

As discussed above with respect to FIG. 1, realizing adjustable white color temperature does not require the flexibility that the RGB combination provides. FIG. 2 is a diagram showing the color temperature control that can be achieved by a combination of two originating colors (cool white and yellow). With two LEDs, colors can only be rendered along a line, rather than within a triangular space like a combination three LEDs can provide. Therefore, the colors that can be rendered are constrained by the colors of the light sources. Line 20 in FIG. 2 represents the range of colors that can be achieved by a combination in varying intensities of a white LED and a yellow LED.

The color point of an LED typically varies significantly due to manufacturing variances and across operating conditions (temperature, forward current, lifetime, etc.). The expected variation of the color produced by a yellow LED (such as an LY_W5SM yellow LED manufactured by OSRAM GmbH of Munich, Germany) is shown by line 20, and the expected variation of the color produced by a cool white LED (such as an LUW_W5AM white LED manufactured by OSRAM) is shown by box 22, giving an overall color point that can potentially vary across the region shown as box 24 (surrounding nominal color temperature line 26, and including the variation within box 22), which may be similar to or substantially different from the black body radiator locus 14. These variations are sometimes referred to as the “binning regions” of the LEDs. This illustrates that the purity of the color temperature produced by lighting is only a function of the color points of the two LEDs, and cannot be controlled simply by variations in intensity.

The combination of a cool white LED and a yellow LED provides an approximation of black body locus 14. The efficacy that results from mixing these two colored LEDs to achieve an overall warm white color is much lower than a white LED of the same color temperature, and is actually slightly lower than the combination of RGB, with present LED technology. The efficacy at the cool white point of line 26 is the same as an equivalent white LED, since it is realized with just a white LED. The low efficacy of the warm white color mix is the result of the inherent low efficacy of the yellow LED. The low efficacy of the yellow LED is due in part to the human eye's low sensitivity to perceive this color. Similarly, substituting a blue LED for the white LED would further lower the efficacy across all color temperatures due to the low efficacy of the blue LED, to which the human eye is also less sensitive.

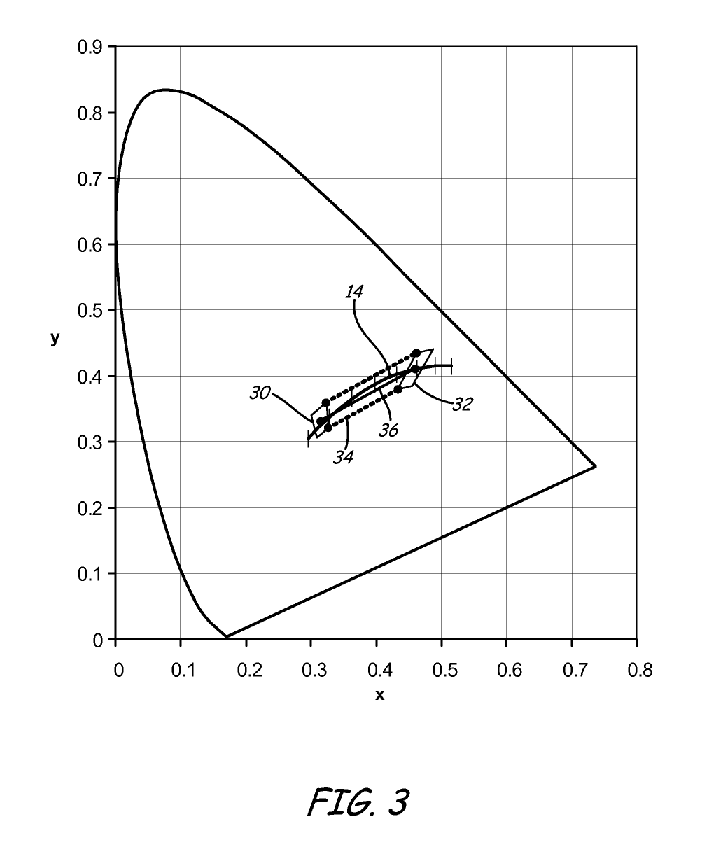

Variable color temperature can also be achieved with a combination of cool white and warm white LEDs. FIG. 3 is a diagram showing the color temperature control that can be achieved by the combination of cool white and warm white lights. Box 30 shows the binning region of cool white LEDs (such as an LUW_W5AM cool white LED manufactured by OSRAM), and box 32 shows the binning region of warm white LEDs (such as an LCW_{—}5AM warm white LED manufactured by OSRAM), giving an overall color point that can potentially vary across the region shown as box 34 (surrounding nominal color temperature line 36, and including the variations within boxes 30 and 32), which provides a level of variation from black body locus 14. With this combination of color sources, a higher efficacy may be achieved compared to the configuration described above with respect to FIG. 2, because the total efficacy is a function of white LEDs which have a higher efficacy than the yellow LED used in the FIG. 2 configuration. Typically, warm white LEDs have a lower luminous flux output than cool white LEDs, and therefore a larger number of warm white LEDs may have to be employed to compensate for the intensity difference between the two colors. This configuration of LEDs may also result in a higher cost than other color combinations.

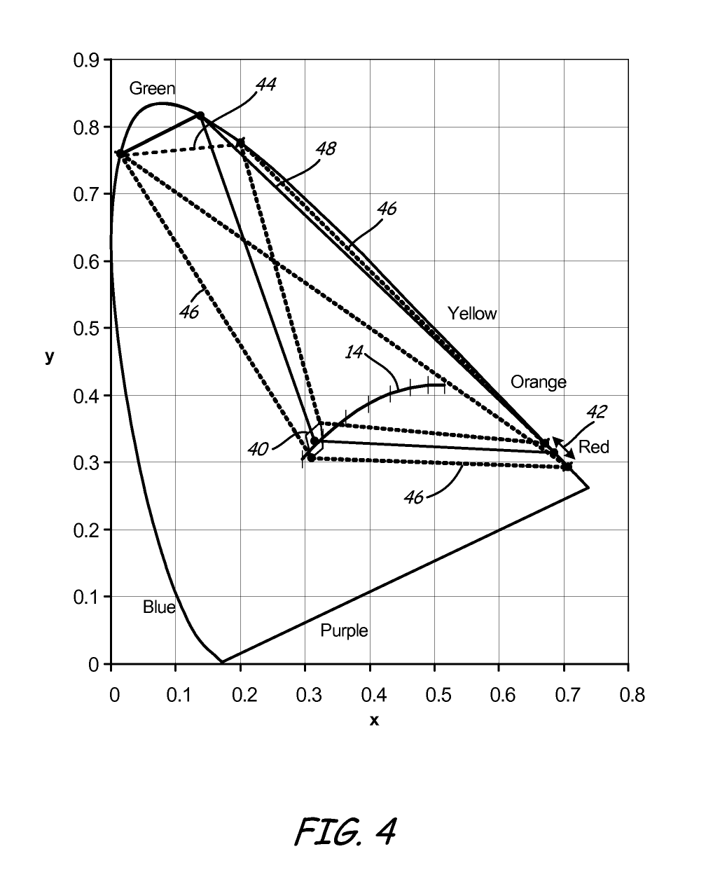

FIG. 4 is a diagram showing the color temperature control that can be achieved by a combination of three originating colors (red, green and cool white). Although RGW does not encompass as large of a color space as RGB, it does encompass the desired color temperature range for approximating black body locus 14, even when accounting for process variations as illustrated by binning region box 40 (cool white), line 42 (red) and line 44 (green), and overall color variance encompassing the region within dashed lines 46 (surrounding nominal color temperature variance region 48, and including the variation within box 40). This combination of LEDs can therefore be used without the need for as careful binning procedures. The RGW combination offers higher efficacies across all color temperatures than RGB by removing the blue LED from the combination, which had the lowest efficacy of the three LEDs in RGB. White LEDs also offer higher efficacies than colored LEDs, and cool white LEDs in particular often offer much higher efficacies than warm white LEDs. In fact, using the combination of RGW to generate warm white color provides a total efficacy that is comparable to a warm white LED alone. Cool white color is generated in the RGW combination by only the cool white LED, and therefore provides the same efficacy as a cool white LED alone. RGW therefore provides more color flexibility than a two-color combination, and also provides very good efficacies across all color temperatures, at a relatively low cost.

Other combinations of three colored LEDs can also be used to realize an array of color temperatures. The three colors must be selected to result in a triangle on the CIE 1931 color space that encompasses the desired color temperature range. To achieve this, it can be seen from the color space diagram that the first color should be in the region of red, amber and orange, the second color should be in the region of green, yellow, orange and warm white, and the third color should be in the region of green, blue, purple and cool white. The combination of colors is selected based on the color needs and efficacy that can be achieved with a specific color. The optimal combination of colors for a particular lighting application, in terms of efficacy and cost, is likely to change with changes in lighting technology.

The efficiency of any color combination can be further improved by running one or more LEDs at a lower forward current. Generally, operating an LED at a lower forward current will improve its efficacy, at the expense of light output. If an LED of lower intensity is employed in a color combination, it may be beneficial to lower the forward current, although the complexity of the overall system may increase with this level of control. In the case of RGW (FIG. 4), driving the red LEDs (which have the lowest efficacy due to the human eye's low sensitivity to red) at a lower forward current boosts the efficacy of the system above a comparable single white LED.

For the application of general purpose lighting with a combination of two or more LEDs, a diffuser or another light combining method may be needed to combine the two or more discrete colors into a single color. The physical construction of the lighting solution involves techniques and construction that are known to those skilled in the art.

LED Driver and Dimming

There are many methods of driving an LED that are well understood in the art. Because the light intensity and color of an LED are a function of its forward current, and an LED's forward voltage varies significantly with process variations, an LED is best suited to be current regulated, which can tolerate the variations in the light source load voltage (although despite this, the present invention may also employ voltage regulation in an alternative embodiment). In a current regulated system, when multiple LEDs are required to realize a single color, the LEDs should be connected in series so that each LED receives the same current (although the LEDs could be connected in parallel in alternative configurations). For each color, the LED strings can consist of different numbers of LEDs.

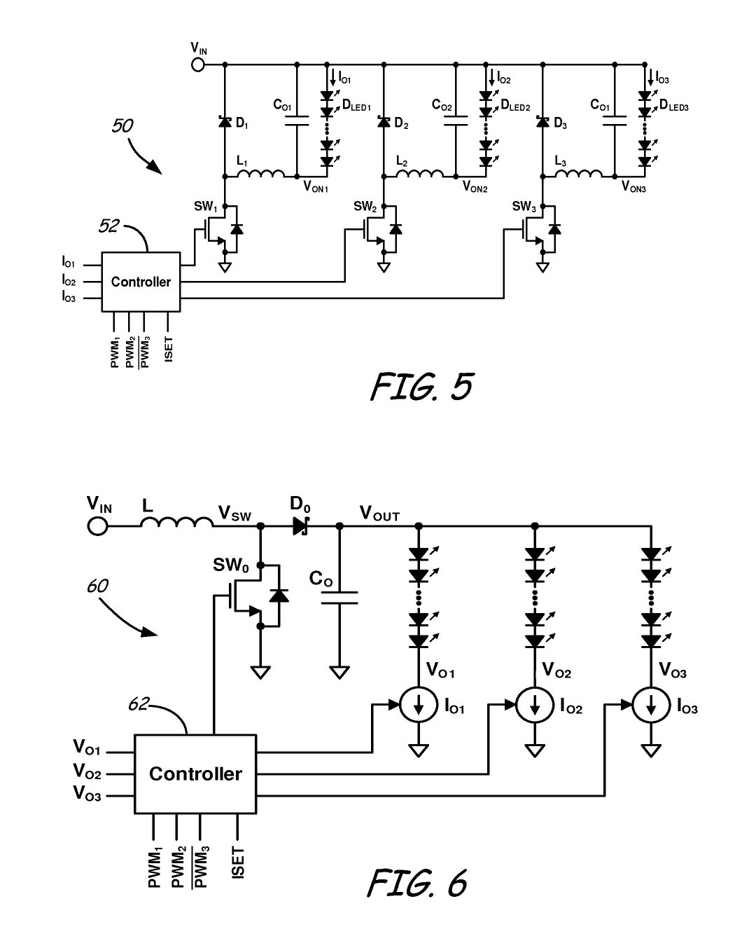

There are many accepted LED driver topologies in the field. FIGS. 5 and 6 are diagrams illustrating two such topologies. FIG. 5 is a diagram of LED driver circuit 50 in which the current in three LED strings is regulated using three separate switch mode power supplies (SMPS) configured as an inverted buck type. The SMPS could be realized using other alternative configurations that are also known in the art, including but not limited to boost and buck-boost configurations. The approach shown in FIG. 5 is very power efficient, but is relatively expensive in terms of component count due to the three discrete inductors that are employed.

FIG. 6 is a diagram of LED driver circuit 60 which employs a single SMPS, and which is configured to regulate the current in the three LEDs with three linear current sinks. To minimize power loss, controller 62 regulates the voltage of the SMPS to minimize the voltages VO1, VO2 and VO3. However, due to the variation in LED forward voltages, LED driver circuit 60 shown in FIG. 6 is less efficient than LED driver circuit 50 shown in FIG. 5. The circuits shown in FIGS. 5 and 6 are illustrative examples of workable LED driver methods, and it should be understood that the present invention may be applied to many other driver methods, including but not limited to switch mode, switch capacitor, and linear drivers.

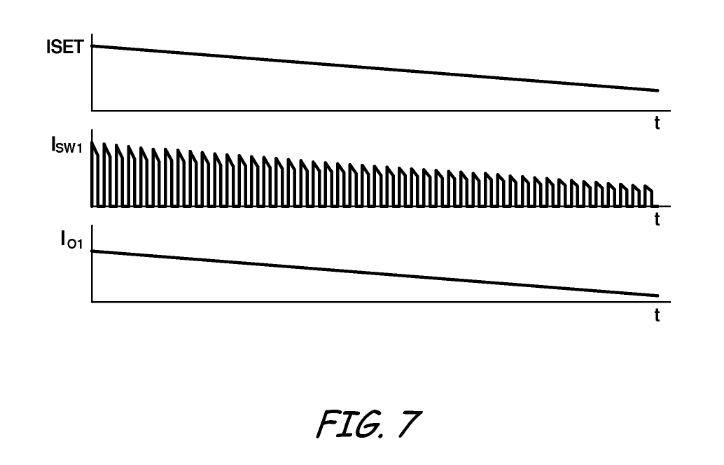

In LED driver circuits 50 and 60 shown in FIGS. 5 and 6, the method of controlling the intensity of an LED string is the same. Since the light intensity of an LED is proportional to the forward current, the light intensity can be controlled by changing the regulated current. The ISET pin of controller 52 in FIG. 5 and of controller 62 of FIG. 6 achieves this regulation. FIG. 7 is a waveform diagram illustrating the effect of changing the value of ISET on the reference current (I_{SW1}) and the forward current (I_{O1}, which applicable to all three channels and all three strings of LEDs. This approach not only results in a change in intensity, but also can cause shifts in the color points of the LEDs. The color shift resulting from changing the forward current can potentially be a problem when mixing multiple LEDs to create a specific color.

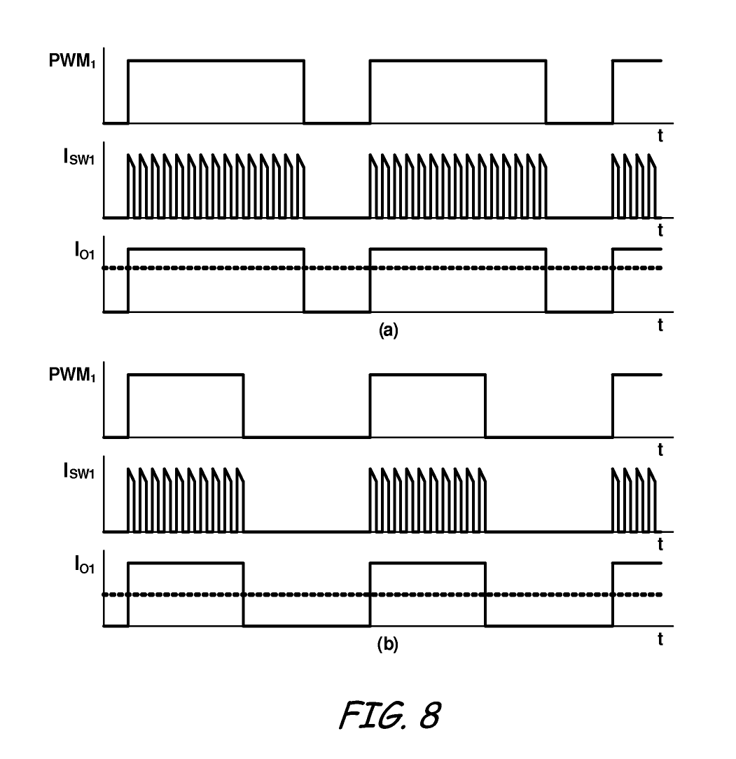

To prevent undesired color shifts, a pulse width modulation (PWM) method can be used to control the intensity of the LEDs. FIG. 8 is a waveform diagram showing a PWM dimming method driving an LED string with a fixed forward current, with the light intensity being controlled by varying the LED on time versus off time (duty cycle) at a fixed frequency. This method allows for light intensity control without color shifts. PWM dimming generally has a fixed frequency that is orders of magnitude (100-1000 times) lower in frequency than the switching frequency of the overall light system, that is, a PWM frequency on the order of 100 Hertz (Hz) to 1 kiloHertz (kHz). FIG. 8 illustrates a first set of waveforms (labeled “(a)”) having a first duty cycle of signal PWM1, resulting in an average current shown in the dashed line in the I_{O1} waveform, and a second set of waveforms (labeled “(b)”) having a second duty cycle lower than the first duty cycle of signal PWM1, resulting in a lower average current shown in the dashed line in the I₀₁ waveform.

Controllers 52 (FIG. 5) and 62 (FIG. 6) have a dedicated PWM dimming input for each LED (PWM₁, PWM₂ and PWM₃) to enable color mixing, although in an alternative embodiment a single input could control all three channels or a combination of channels. The signal input to pin PWM₁ pin is shown in FIG. 8, which simply turns on and off the corresponding channel when a logic high or low is provided. An alternative input method is to provide an analog signal that corresponds to the desired duty cycle. In this case, the controlled would decode the analog signal into the digital PWM signal shown in FIG. 8, using techniques that are known to those skilled in the art.

Color Temperature Control

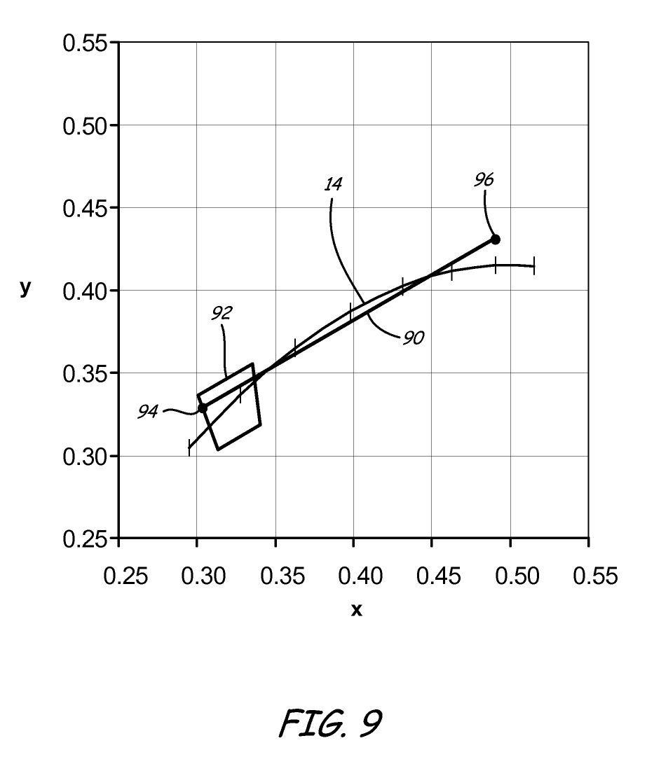

FIG. 9 is a diagram illustrating the non-linear nature of black body radiator locus 14 for color temperature in the CIE 1931 color space. Prior art lighting systems use non-linear control methods to attempt to control colored light sources to fit this curve precisely. However, as shown by line 90 in FIG. 9, a linear fit to the black body radiator locus, which is provided by the present invention, is a very good approximation of the black body radiator locus at a variety of color temperatures. In fact, this fit is slightly better than the range of color temperatures that simply results from process variations in white LEDs. The binning region for a white LED (such as the LUW_W5AM white LED manufactured by OSRAM) is shown by box 92 in FIG. 9, which has a wider fit to black body radiator locus 14 than linear fit 90. Also, it should be understood that the present invention is able to provide a linear fit to any non-linear target lighting behavior, of which the black body radiator locus is but one example.

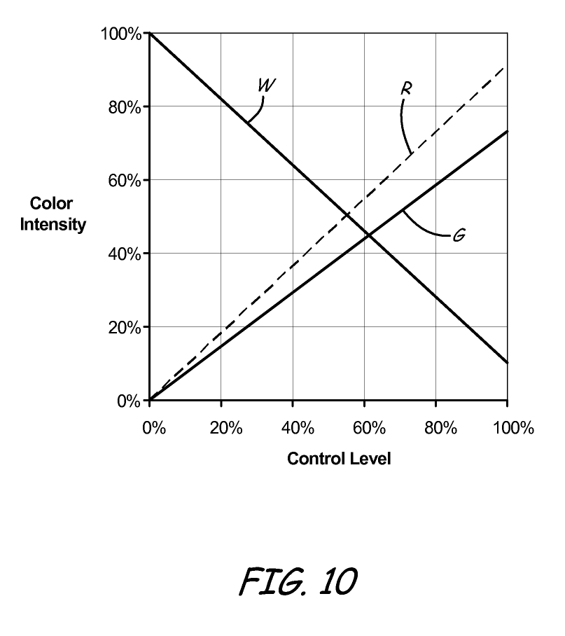

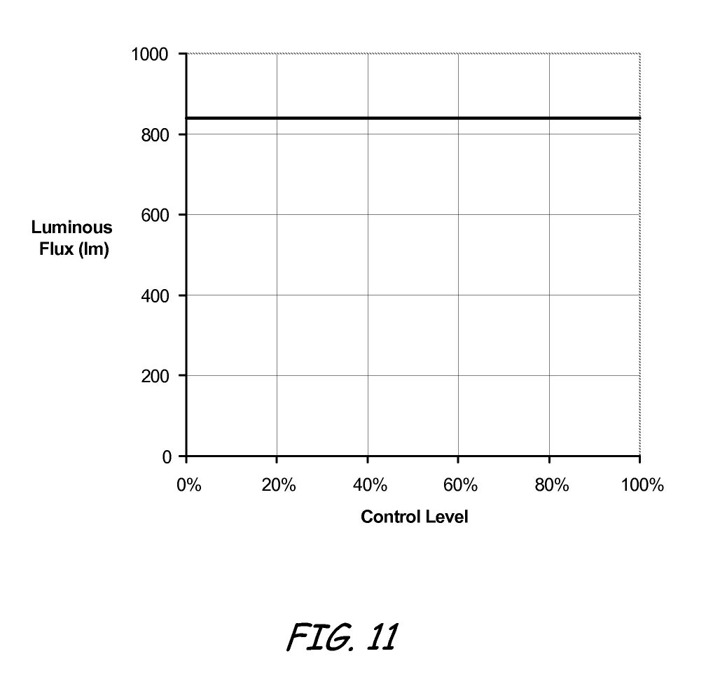

The benefit of the linear fit is more clearly illustrated in FIG. 10, which is a diagram showing a plot of the individual color intensities of red (R), green (G) and white (W) to provide color temperature line 90 in FIG. 9. The relationship between the different colors, as shown in FIG. 10, is completely linear, which makes control of each color very straightforward. This is true for any three color combination, not just for RGW. As long as the color temperature line is linear in the CIE 1931 color space, the intensity relationship of the individual colors to realize the overall color temperature will also be linear. This approach of linearly controlling the color point can also be applied to color regions other than the color temperature of white.

In addition to the linear intensity relationship, the configuration of the linear color fit is also simple. For an RGW combination, the left-most point 94 of line 90 in FIG. 9 is defined by the color point of the white LED, which falls within the binning region (box 92) shown. This color point corresponds to the 0% control level in FIG. 10. On the other side, the right-most point 96 of line 90 in FIG. 9 corresponds to the 100% control level in FIG. 10, which defined by a mix of all three colors. Therefore, the color point at the right-most point 96 of line 90 in FIG. 9 can be controlled to a position anywhere within the operating triangle 48 of FIG. 4 (that is, the cool white point at the left-most end 94 of line 90 is fixed according to the color temperature of the cool white LED, while the warm white point at the right-most end 96 of line 90 can be tuned by controlling the color mixture).

The present invention is also applicable to configurations in which the color points of both ends of the linear fit curve are adjustable. This flexibility is offered by solutions that employ three or more LEDs. The fit curve can be configured to account for color shifts incurred by high temperature, the lifetime of the part, or other factors. This configuration can be performed a single time at the initial setup of the lighting system. The linear fit could also be configured adaptively based on feedback of the color point, temperature, or other inputs to the lighting system. The change to the linear fit curve could be performed continuously at any color point, or the change could be made afterward using the recorded effect of more than one color point. The simplicity of the linearization allows such adjustments to be performed more readily than a nonlinear control system.

In addition to the color point, the intensity of the light must also be considered when configuring the color mix for warm white. The color point results from the average of the three colors, and the intensity results from the sum of the three colors. Once the ratios of the three colors have been established for the desired color point, the intensity can then be adjusted by changing the intensity of all three LEDs while keeping their relative ratios the same. Then the intensity at the warm white color point is tuned to complement the cool white color point, the intensity across all color temperatures will remain constant, as shown in FIG. 11, which is a diagram of the luminous flux achieved for various control levels. This allows the color temperature to be controlled independent of the intensity.

The color mix shown in FIGS. 9, 10 and 11 was realized with eight LEDs in each color string, using OSRAM's LA_W5SM LEDs for red, LT_W5AM LEDs for green, and LUW_W5AM for white. The combination generates enough luminous flux to replace a 60 Watt incandescent light bulb. Each color of LED generates a different luminous intensity, which impacts the color mix at the warm white color point. Therefore, different types of LEDs will result in a different color mix. For the selected LEDs described above, only 73% of the green LEDs' maximum output is needed in the color mix. The number of green LEDs therefore can be reduced to six or seven in order to reduce cost. Also, as described earlier, the green LEDs could be driven with a lower forward current to produce a higher efficacy.

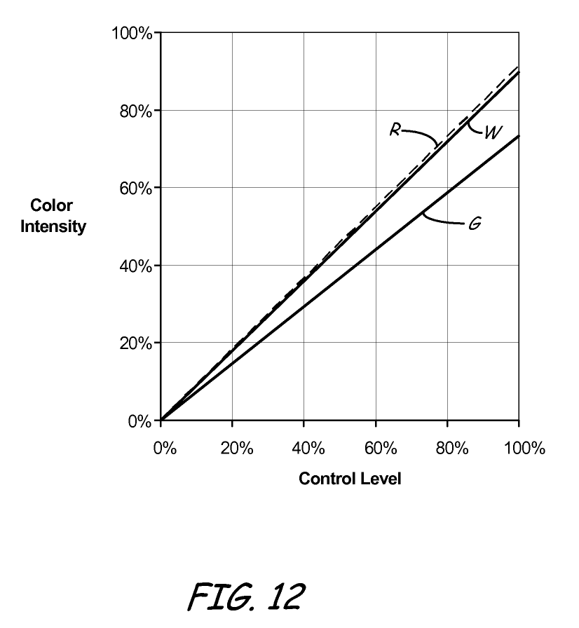

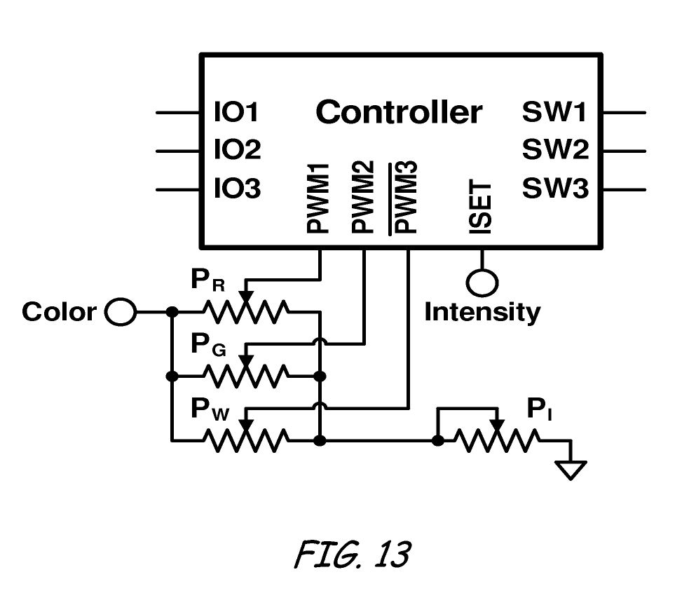

A simpler version of the control scheme may be achieved when the intensity control relationship of the white LED shown in FIG. 10 is inverted. FIG. 12 is a diagram showing the inverted control of the white LED, illustrating that in this configuration the color intensities are linear and all intersect at the same point (zero). Therefore, the color intensity functions are simply a gain function, which can be easily realized using basic components. This holds true as long as all three colors have the same intersection for one control signal (such as zero in this example). One realization is to implement each gain with a variable resistor divider (a potentiometer) so that the color mix can be easily tuned. FIG. 13 is a circuit diagram showing such a realization with a controller that has all analog inputs, internally converting the PWM inputs to perform the PWM dimming function described earlier. In addition to the three potentiometers (PR, PG and PW) for each color, there is a fourth potentiometer (PI) for setting the intensity. This allows the intensity to be tuned without impacting the color ratios that are defined for the color point. The network of potentiometers is driven by a control signal, labeled “Color” in FIG. 13, to control the color temperature. This control signal is a DC voltage, and can originate from any suitable source. For example, the phase angle relationship generated by a TRIAC dimmer may be decoded to drive this input. In some embodiments, a microcontroller may be used to decode communication from a wired or wireless bus to control this input. Other options are also possible.

The realization of the resistor divider network is not limited to the potentiometers shown in FIG. 13. The gain function that the resistor dividers provide could be realized with digital potentiometers, a digital to analog converter, or some other device for performing the same function. The resistor divider network could also be replaced by some form of microcontroller (processor, field programmable gate array (FPGA), etc.), or digital logic implementing the linear function. The control interface is also not limited to the disclosed analog interface, as the same function could be realized using a digital PWM interface or a digital bus interface such as I2C. The advantage of the linear approach shown in FIG. 13 is its simplicity, enabling a less complex and costly solution. The linear approach also provides the ability to easily adapt the linear fit of the light by changing the gain function. The gain function can be controlled at the initial setup of the lighting system or adapted based on feedback such as the color point, temperature, or some other input.

In the exemplary embodiments, the linear fit is applied by open loop control of the light sources. The linear fit to the black body radiator can also be used as a reference to a lighting system with optical feedback. In such a system, the lighting sources would be controlled by one or more control loops that adjust the optical output to drive optical feedback to equal a reference value. The linearization of the CIE 1931 color space could be applied to this system by adjusting the gain of the feedback and/or the reference value.

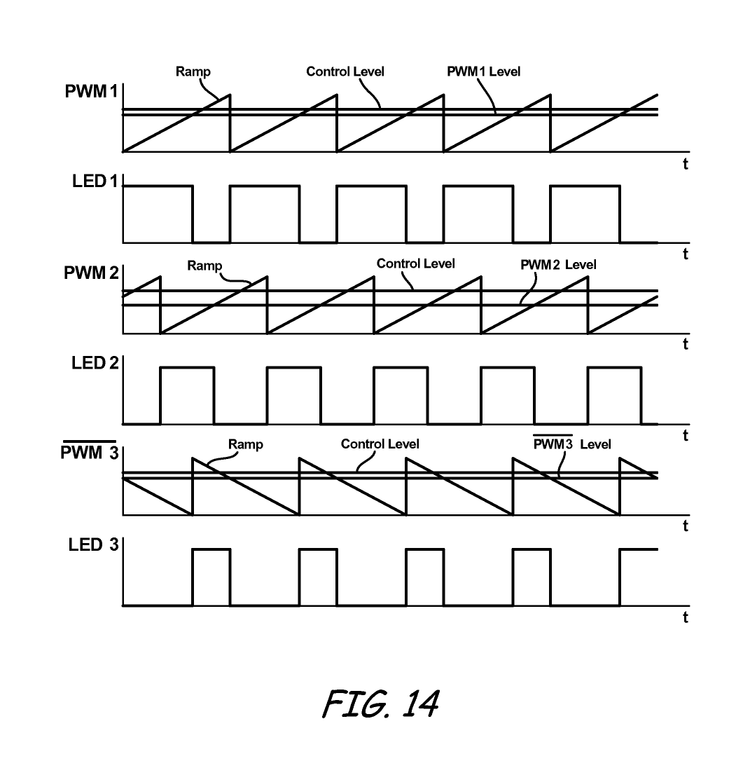

As shown in FIG. 13, the control signals for the three colors are voltage signals, and therefore the controller must translate those DC signals into digital PWM signals. This is often done by comparing the DC control voltage signal against a sawtooth waveform. FIG. 14 is a waveform diagram illustrating this scenario for all three channels. The inversion of the third channel waveform is accomplished in FIG. 14 by inverting the sawtooth waveform and the comparison. This is done so that the rising edge of the inverted PWM signal occurs at a consistent phase relationship to the other channels. Alternatively, the digital output of the comparison could be inverted without changing the sawtooth waveform, at the expense of a varying rising edge phase relationship. Other methods may also be used to realize the function of the inverted PWM input.

In a particular embodiment, a fixed voltage offset may be employed in order to adjust, or program, the color point that is achieved at the zero control point. One configuration of this embodiment involves the coupling of a voltage source in series with each of potentiometers PR, PG and PW shown in FIG. 13.

FIG. 14 also illustrates a phase shift between the three sawtooth waveforms, which provides a phase shift in the turn-on point of the three LED currents. Without this phase shift, all of the LEDs would turn on at the same time, which puts more stress on the input supply and requires larger input supply filter components. Though PWM dimming provides high performance, it is also possible in alternative embodiments for the three control signals for adjusting the color temperature to control an analog dimming function to control the intensity of each channel, which changes the LED forward current, instead of varying the on and off time of the LEDs.

The operation of the circuit of FIG. 13 will now be explained in more detail, referencing the waveform diagram of FIG. 14. Each PWM plot in FIG. 14 includes the “Color” input from FIG. 13 labeled “Control Level,” and each PWM input labeled “PWM Level.” The “PWM Level” illustrates the effect of the resistor divider network, with the same “Control Level” signal resulting in a different “PWM Level” for each channel, determined by the different gains of the resistor divides for each channel. FIG. 14 also illustrates the PWM waveform for each corresponding LED, which is generated by comparing the “PWM Level” signal to the sawtooth waveform.

In addition to the color temperature control provided by PWM dimming, the controller of FIG. 13 is also configured to control the intensity of the light, independent of the color temperature. This is accomplished in a simple manner, by employing analog dimming (described above) to control the intensity. The ISET input (FIG. 13) controls the reference for current regulation of all three channels. By adjusting ISET, the forward current of all three LED strings is uniformly scaled so that the intensity is adjusted without impacting the relative intensity relationships of the channels set by the PWM inputs. However, changing the forward currents of the LEDs changes the color point of each LED, which impacts the color temperature. This is not critical because the color shift occurs while changing the intensity of the light, and the human eye is unlikely to be able to perceive the color shift very well due to the more significant change in the intensity. Using PWM dimming to control color temperature instead of analog dimming is preferable in some embodiments because the color temperature adjustment is more sensitive to color shifting than intensity adjustments. This is because the human eye is very good at perceiving changes is color but is poor at perceiving a difference in intensity of a single light. Similar to the color temperature control, the control signal for intensity can also originate from a TRIAC dimmer or some type of wired or wireless but, for example.

An alternative technique would be to use PWM dimming to control both color temperature and intensity. The fourth potentiometer PI in FIG. 13 controls the intensity via PWM dimming. This adjustable resistor technique can therefore be used as a control input for intensity. The adjustable resistor could be voltage controlled using either analog techniques or digital techniques that are well known in the art. Adjustable intensity could also be realized by adjusting the sawtooth waveform. To increase the intensity, the slope of the sawtooth ramp for all three channels is decreased, which increases the duty cycle proportionally for all three channels. Increasing the slope of the ramp will decrease the intensity. Another approach is to modify the input signal at each PWM input with some type of adjustable gain circuit. This could be realized with a multiplier or divider that is uniformly adjusted across all three channels. The sawtooth waveform comparison technique could also be realized using digital techniques by implementing the ramp function with a counter and comparing that count against a number generated from the control input. In this embodiment, the counter could be modified, to adjust the light intensity, by increasing or decreasing the frequency at which the count is updated, but keeping the period of the count the same, which changes the value of the final count. The same function could also be accomplished by skipping numbers in the count sequence. In addition, the number generated by the control input could also be modified by a digital multiplier or divider.

Both adjustable color temperature and intensity could also be realized with analog dimming. This approach does not necessarily provide a performance benefit, but it can reduce the complexity of the control circuitry employed. Instead of the three PWM inputs shown in FIG. 13, three analog dimming inputs would be provided to independently control each channel. The adjustable resistor technique (potentiometer PI in FIG. 13) and the signal modifier for each input discussed above for PWM dimming could also be applied to analog dimming. In some embodiments, analog dimming could be dedicated only to the color temperature adjustment, leaving PWM dimming to control intensity, which may reduce the control complexity of the system.

All of the above-described techniques for color temperature and intensity control are not limited to the RGW example, but can be applied to any combination of lights, involving other colors or a different number of colors (two or more).

Color Temperature Control with Correlated Intensity

In many traditional lighting solutions, such as incandescent or halogen lights, the color temperature of the light changes with intensity. At full brightness, these lights have a cool color temperature, while at low light they have a very warm color temperature. This characteristic can be beneficial in setting the mood of the light, and also simplifies the control of the light with a single user input. This effect can be recreated in the color temperature and intensity control of the present invention.

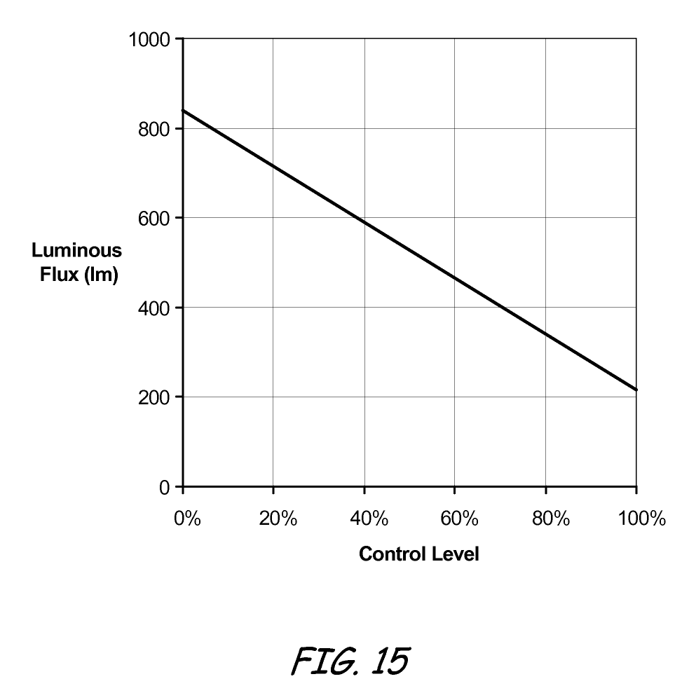

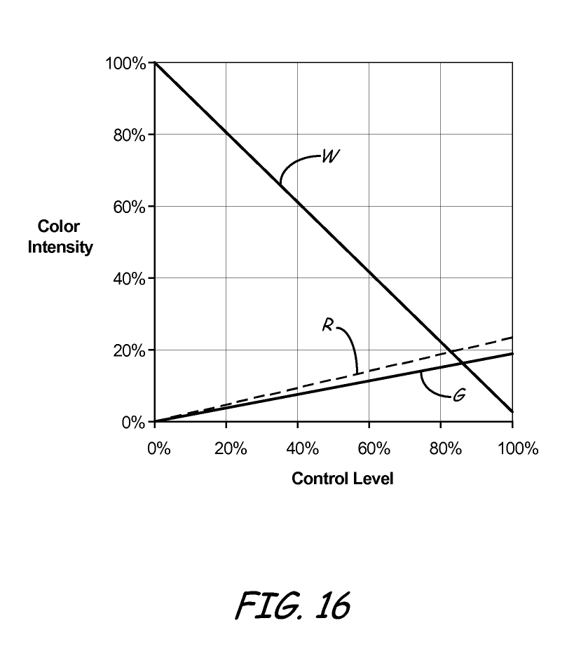

In this embodiment, instead of having two inputs as illustrated in FIG. 13, the control input for the resistor divider network is the only input. The embodiment shown in FIG. 13 was previously configured so that the intensity potentiometer PI was employed to keep the intensity fixed across all color temperatures. However, in this modified embodiment, intensity adjustment via potentiometer PI should be performed so that intensity decreases as the color temperature changes from cool to warm white. FIG. 15 is a diagram illustrating this relationship between luminous flux and control level, and FIG. 16 is a diagram illustrating the color intensity relationship that results (using the same hardware as the previous example, including eight LEDs in each LED string). The fit to the color temperature curve remains the same as shown in FIG. 9. The light intensity at the warm white color point can be configured at any intensity, higher or lower than the cool white intensity.

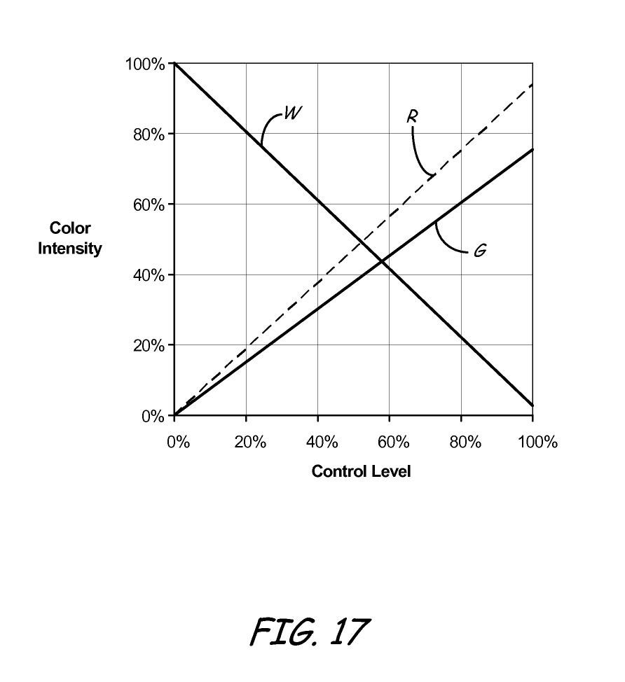

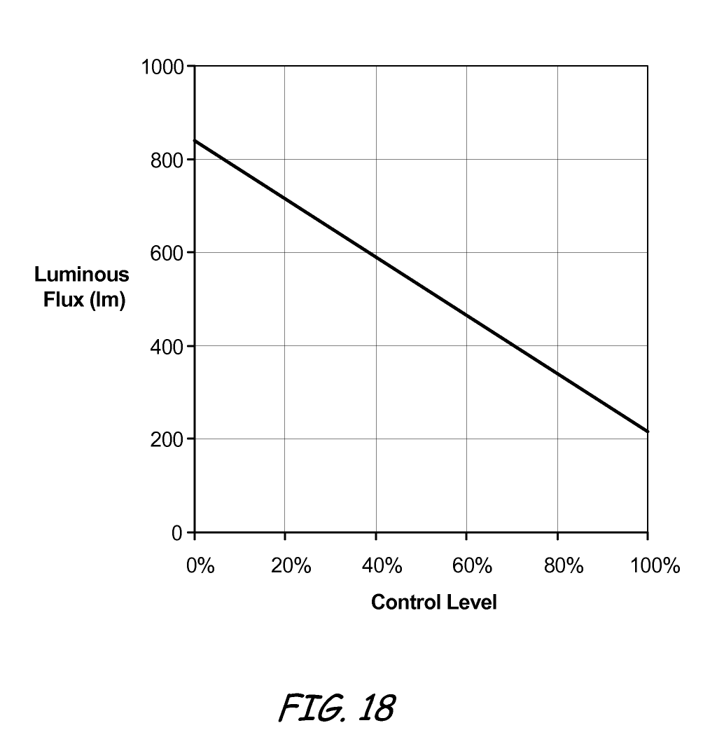

FIG. 16 shows that the red and green LED strings are under utilized, considering that their maximum operating intensity is about 20% of their maximum rating. Therefore, the number of LEDs in the red and green strings can be reduced to as few as two LEDs (from eight LEDs) to save cost. FIG. 17 is a diagram of the resulting color intensity relationship from the reduction to two LEDs in the red and green strings, and FIG. 18 is a diagram of the luminous flux output for various color temperatures (again having color temperature correlated with intensity). The relative intensities are unchanged from those shown in FIG. 16. This is possible because the light is no longer running at full intensity in the warm white region (due to the reduced overall intensity at that color temperature), requiring fewer LEDs to render that color. A higher efficacy could also be achieved by reducing the forward current of the red and green LEDs, keeping in mind that reducing forward current results in higher efficacy at the expense of light output.

The techniques described for realizing adjustable color temperature with correlated intensity can be applied to combinations of LEDs other than the RGW combination disclosed as an example. These techniques are applicable to other color combinations and to other numbers of colors (two or more). For example, low intensity warm white may be a good application of the two LED combination described above, involving cool white and yellow LEDs (see description of FIG. 2) or cool white and warm white LEDs (see description of FIG. 3). The relatively low efficacy and accuracy of these solutions are less important at reduced light intensity.

The present invention, described with respect to a number of exemplary embodiments, provides a system for combining multiple colors to achieve a general purpose lighting solution that is simply and efficiently realized and controlled.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A lighting system comprising:
at least a first light source providing a first color of light and a second light source providing a second color of light;
control circuitry operatively coupled to the first and second light sources and being configured to control the first and second light sources relative to one another to provide a color point that is linearly controlled to approximate a non-linear target lighting behavior in the CIE 1931 color space.

2. The lighting system of claim 1, wherein the first and second light sources are light emitting diodes (LEDs).

3. The lighting system of claim 1, wherein the first light source is a cool white colored light and the second light source is a yellow colored light.

4. The lighting system of claim 1, wherein the first light source is a cool white colored light and the second light source is a warm white colored light.

5. The lighting system of claim 1, further comprising at least a third light source providing a third color of light, wherein the control circuitry is configured to control the first, second and third light sources to provide a color point that is linearly controllable between two endpoints to fit the non-linear target lighting behavior in the CIE 1931 color space.

6. The lighting system of claim 5, wherein the first light source is a cool white colored light, the second light source is a red colored light, and the third light source is a green colored light.

7. The lighting system of claim 1, wherein the control circuitry comprises:
first and second switched mode power supplies (SMPSs) coupled respectively to the first and second light sources to controllably direct current through the light sources.

8. The lighting system of claim 1, wherein the control circuitry comprises:
a switched mode power supply (SMPS) coupled to both the first and second light sources; and
first and second current sinks coupled respectively to the first and second light sources to control the current directed through the light sources by the SMPS.

9. The lighting system of claim 5, wherein one of the two endpoints is fixed by virtue of the first light source being configured to provide a first endpoint color, and the second endpoint is variable by virtue of the second light source being combined with the third light source in a manner controlled to provide a second endpoint color at a selected color.

10. The lighting system of claim 1, wherein the non-linear target lighting behavior is a black body radiator locus in the CIE 1931 color space, and the color point is controlled linearly between a cool white and a warm white color temperature.

11. A control system for controlling intensity of a lighting system that includes at least a first light source providing a first color of light and a second light source providing a second color of light to provide a color point that is linearly controlled in the CIE 1931 color space, the control system comprising:
power supply circuitry coupled to the first and second light sources for delivering power to the first and second light sources; and
a controller coupled to the power supply circuitry to control intensities of the first and second light sources, the controller connected to receive a first control signal to adjust the intensity of the first light source and a second control signal to adjust the intensity of the second light source.

12. The control system of claim 11, wherein the first and second control signals are pulse width modulated (PWM) control signals for controlling the intensity of each light source via PWM dimming.

13. The control system of claim 12, wherein the controller is connected to receive an additional control signal to adjust the intensity of all light sources via analog dimming.

14. The control system of claim 11, wherein the first control signal for the first light source is inverted with respect to the second control signal for the second light source.

15. The control system of claim 11, wherein the control signal for each light source is produced by a gain circuit.

16. The control system of claim 15, wherein the gain circuits comprise a network of potentiometers and the control signals comprise a color temperature signal and an intensity signal.

17. The control system of claim 15, wherein an offset is added to at least one of the control signals to program a color temperature at zero gain of the gain circuit for that control signal.

18. The control system of claim 11, wherein the color point is linearly controlled between cool white and warm white color temperatures to fit a black body radiator locus in the CIE 1931 color space.

19. The control system of claim 18, wherein the lighting system further comprises at least a third light source providing a third color of light, and wherein the control system is configured to control the first, second and third light sources to provide the overall color temperature that is linearly controllable between the cool white endpoint and the warm white endpoint to fit the black body radiator locus in the CIE 1931 color space.

20. The control system of claim 19, wherein the first light source is a cool white colored light, the second light source is a red colored light, and the third light source is a green colored light.

21. A control system for controlling intensity of a lighting system that includes at least a first light source providing a first color of light and a second light source providing a second color of light to provide a color point that is adjusted by control inputs, the control inputs comprising:
at least a first control input that controls an intensity of the first light source proportional to the first control input; and
at least a second control input that controls an intensity of the second light source inversely proportional to the second control input.

22. The control system of claim 21, wherein the control inputs comprise pulse width modulated (PWM) dimming inputs.

23. The control system of claim 21, wherein the control inputs comprise an analog dimming input.

24. The control system of claim 21, wherein the control inputs further comprise a third input to control intensities of the first and second light sources with the same relationship.
